(19) United States
(12) Patent Application Publication
(10) Pub. No.: US 2022/0073254 A1
(43) Pub. Date: Mar. 10, 2022

(54) ALIGNER CASE WITH CLEANING PORTS AND METHODS OF MANUFACTURING AND USING SAME

(71) Applicant: Khaled Eldin, Old Bridge, NJ (US)

(72) Inventor: Khaled Eldin, Old Bridge, NJ (US)

(21) Appl. No.: 17/014,448

(22) Filed: Sep. 8, 2020

(51) Int. Cl. B65D 81/22; A61C 17/00

(52) U.S. Cl. CPC B65D 81/22; A61C 17/0205; A61C 17/036

(57) ABSTRACT

An aligner case includes a body having a floor and a sidewall and an inner cavity, the body having at least one inlet in at least one of the floor and the sidewall, and the body having at least one outlet in at least one of the floor and the sidewall, at least one door coupleable to the sidewall and transitionable between an open condition where the inner cavity is revealed, and a closed condition where the inner cavity is covered, and an actuator configured to allow transitioning of the at least one door between the open condition and the closed condition.

### FIELD OF THE DISCLOSURE

The present disclosure relates to aligner cases. More particularly the present disclosure relates to aligner cases that having cleaning ports.

### BACKGROUND OF THE DISCLOSURE

Aligners are orthodontic devices used to adjust teeth. Typical aligners are transparent, plastic devices that may be used to gradually adjust the spacing between teeth. A mold or scan of the patient's teeth is first taken and a series of aligners are custom made to reposition the patient's teeth in stages as desired.

Slim cases are used to hold the aligners when they are not in use or during travel. Generally, users clean their aligners by adding some combination of water, soap, vinegar, baking soda, hydrogen peroxide or other suitable solution to a glass, and soaking the aligner in the glass. However, this additional step makes the cleaning process cumbersome and allows for contamination of the aligner when moving it out of the case, into the glass, out of the glass, and back to the user's mouth.

### SUMMARY OF THE DISCLOSURE

In some embodiments, an aligner case includes a body having a floor and a sidewall and an inner cavity, the body having at least one inlet in at least one of the floor and the sidewall, and the body having at least one outlet in at least one of the floor and the sidewall, at least one door coupleable to the sidewall and transitionable between an open condition where the inner cavity is revealed, and a closed condition where the inner cavity is covered, and an actuator configured to allow transitioning of the at least one door between the open condition and the closed condition.

### BRIEF DESCRIPTION OF THE DISCLOSURE

Various embodiments of the presently disclosed aligner cases are described herein with reference to the drawings, wherein:

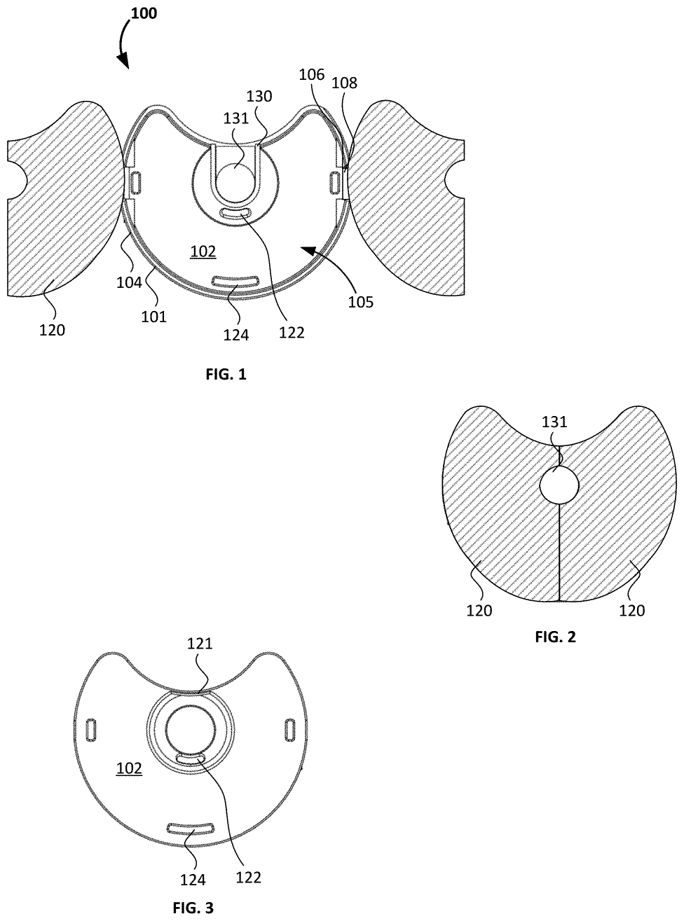

FIG. 1 is a schematic top view of an aligner case with the doors open according to one embodiment of the present disclosure;

FIG. 2 is a schematic top view of the aligner case of FIG. 1 with the doors closed;

FIG. 3 is a schematic bottom view of the aligner of FIG. 1;

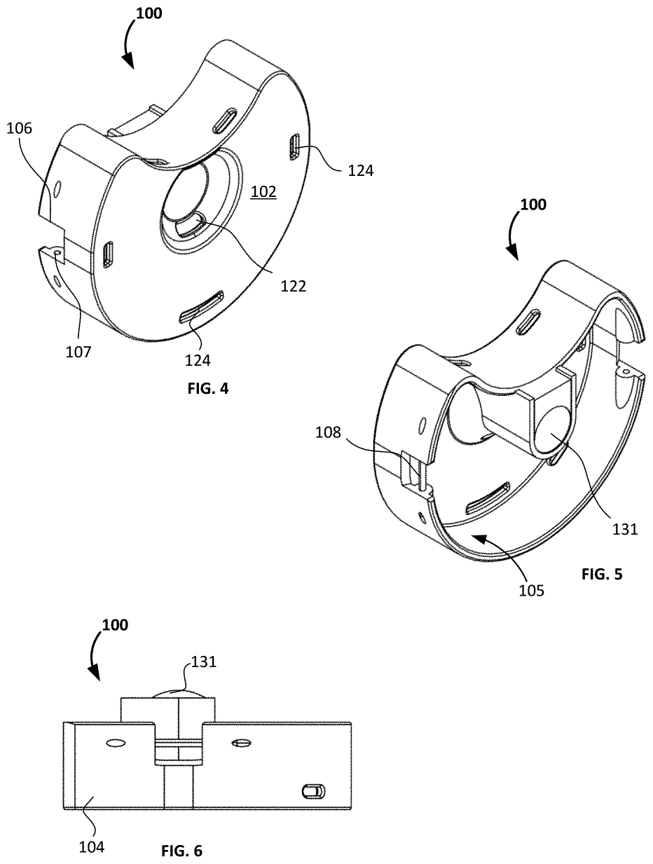

FIGS. 4-5 are schematic perspective views of the aligner case of FIG. 1;

FIG. 6 is a schematic side view of the aligner case of FIG. 1;

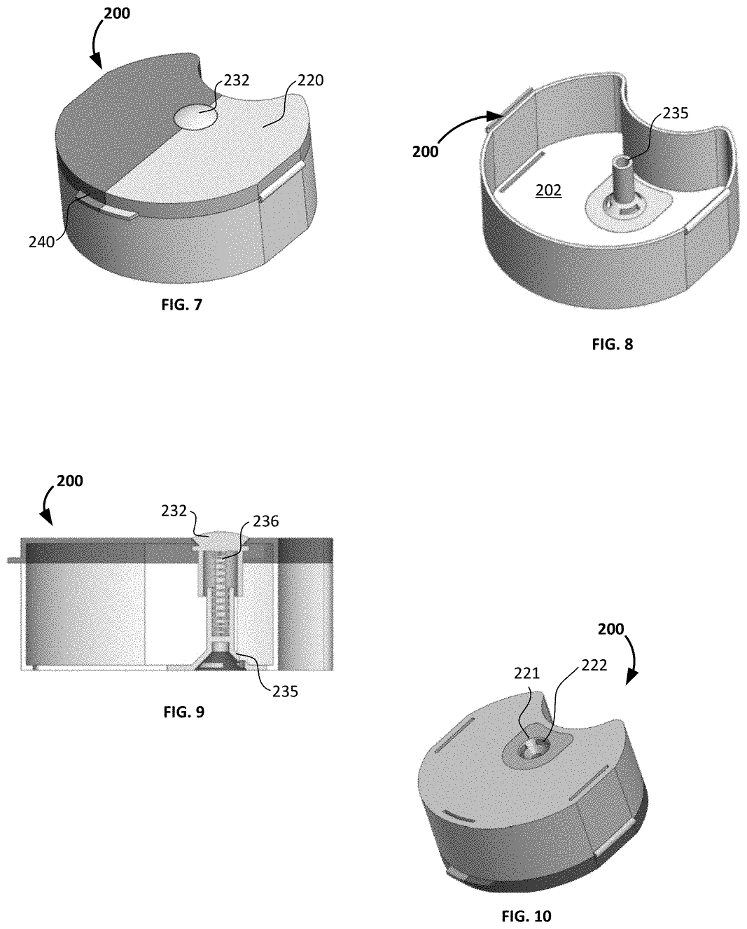

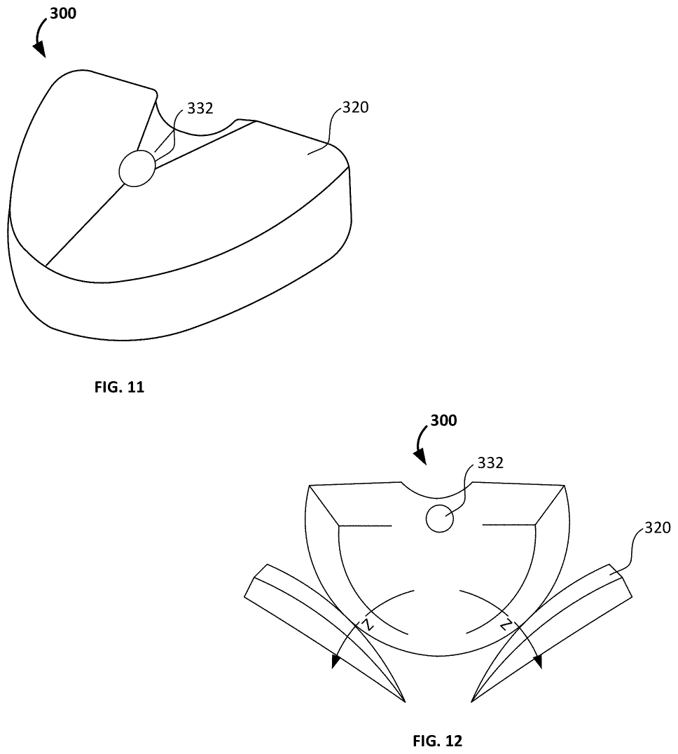

FIGS. 7-10 are schematic perspective and cross-sectional views of another example of an aligner case according to the present disclosure; and

FIG. 11-12 are schematic perspective and top views of another example of an aligner case according to the present disclosure.

Various embodiments of the present invention will now be described with reference to the appended drawing. It is to be appreciated that these drawings depict only some embodiments of the invention and are therefore not to be considered limiting of its scope.

### DETAILED DESCRIPTION

Despite the various improvements that have been made to aligner cases, conventional devices suffer from some shortcomings as described above.

There therefore is a need for further improvements to the devices, systems, and methods of manufacturing and using aligner cases. Among other advantages, the present disclosure may address one or more of these needs.

As used herein, the term “proximal,” when used in connection with a component of an aligner case, refers to the end of the component closest to the user, whereas the term “distal,” when used in connection with a component, refers to the end of the component farthest from the user.

FIGS. 1-6 illustrate schematic views of one example of an aligner case 100. As shown, aligner case 100 generally includes a body 101 having a floor 102 and a sidewall 104. The body 101 may comprise a plastic, metal or other suitable material and may be formed to define an inner cavity 105 shaped to accept an aligner. In at least some examples, body 101 is semi-circular, dome-shaped or kidney-shaped as shown. Floor 102 may be generally flat as shown, and a continuous sidewall 104 may extend about the perimeter of the floor 102. In some examples, sidewall 104 may include a pair of notches 106 on opposing sides of the body (best seen in FIG. 4), and may have one or more receivers 107 to hold a pin 108, which acts as part of a hinge for the doors.

Doors 120 are shown in FIGS. 1-2 in their open condition and closed condition, respectively. The doors 120 have been removed from other figures so that the inner cavity 105 can be better seen. As shown in FIGS. 1-2, the doors 120 couple to pins 108, which acts as a hinge the doors being capable of rotating about pins 108. Doors 120 completely cover the inner cavity 105 in the closed condition (FIG. 2) and expose the inner cavity 105 in the open condition (FIG. 1). In some examples, the two doors are symmetric. It will be understood that the aligner case 100 may include a single door, or more than two doors (e.g. three, or four doors).

Turning to FIG. 3, a depression 121 (e.g., a circular depression) may be formed on the bottom surface of floor 102 in the middle of the floor. One or more inlets 122 may be formed at or near depression 121. In at least some examples, inlet(s) 122 are generally arc-shaped ports that allow water or other liquid or substance(s) to be communicated to the inner cavity. In at least some examples, aligner case 100 includes multiple inlets 122 (e.g., two, three, four or more inlets) disposed at or adjacent depression 121. As best seen in FIG. 4, inlet 122 may be disposed at depression 121 so that it is angled with respect to the floor and the sidewall. This arrangement may help direct water or other solution through the inlet toward the sidewall of the aligner case 100, and allow the cleaning agent to swirl within the inner cavity to clean an aligner.

Additionally, one or more outlets 124 may be formed in floor 102. In the example shown, outlet(s) 124 are arc-shaped ports that are disposed adjacent the outer circumference of floor 102. Three outlets 124 are shown in floor 102 in this example. Instead of, or in addition to the outlets 124 in the floor, outlets 124 may be formed in the sidewall. In some examples, the sidewall includes two, three, four, five, six, seven or eight outlets.

An inner wall or column 130 may be disposed in inner cavity 105, the inner wall defining a space for housing the actuating mechanism of the case and protecting this mechanism from a cleaning agent. In the example shown, the actuating mechanism includes a button 131 seated on a spring (not shown). Doors 120 may be transitionable between an open condition and a closed condition, and may be biased to return to the open condition when no external force is applied thereto, and to be retained in the closed condition by the actuating mechanism. In addition, the actuating mechanism may be configured to release the doors when pressed so that the doors return to the open condition.

In use, the device 100 may receive an aligner and the user may close the doors 120 to house the aligner in the interior cavity 105 of the device. With the aligner secured within the interior cavity, the aligner case 100 may be used to store and/or transport the aligner. When the user wishes to use the aligner, they may first introduce water or other cleaning solution through the inlet(s) 122 at the bottom of the device. The cleaning solution will fill the interior cavity and the water will deflect off the inner sidewalls to wash the aligner disposed in the case. Water will also exit through the outlets of the device. After the aligner is thoroughly rinsed or cleaned, the user may shake the case to remove the excess water or other solution from the interior cavity, and may then push the buttons to open the door and retrieve the aligner that is cleaned and ready for use.

Variations of the aligner case are possible. FIGS. 7-10 illustrate another embodiment and also serves to better illustrate one example of an actuating mechanism. Aligner case 200 is similar to aligner case 100 but includes a pair of tabs 240 at the front of the case to help in opening and closing doors 220. As shown in FIGS. 8-9, an exemplary actuating mechanism may include a seat 235 coupled to and projecting from floor 202, a button 232 and a spring 236 disposed between the seat and the button. In this variation, a depression 221 is formed at the bottom of the device in the floor, and the floor defines three equally-spaced inlets 222 approximately 120 degrees from one another.

Other variations are also possible, for example, in the manner in which the doors operate. As previously described, an aligner case may include a single door or multiple doors. For example, a single hinged door may open to one side or to the front or back of the aligner case. Alternatively, as shown in FIGS. 11-12, the doors 320 may open in a different manner than those previously described. In this figure, button 332 allows aligner case 300 to open the doors 320 in a barn-style so that the doors flip open toward the front of device away from button 332 as indicated by arrows “Z”. It will be understood that other configurations and arrangement are possible.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. An aligner case, comprising:
a body having a floor and a sidewall and defining an inner cavity, the body having at least one inlet in at least one of the floor and the sidewall, and the body having at least one outlet in at least one of the floor and the sidewall;
at least one door coupleable to the body and transitionable between an open condition where the inner cavity is revealed, and a closed condition where the inner cavity is covered; and
an actuator configured to allow transitioning of the at least one door between the open condition and the closed condition.

2. The aligner case of claim 1, wherein the at least one door includes two doors.

3. The aligner case of claim 1, wherein the at least one inlet comprises a single inlet in the floor.

4. The aligner case of claim 1, wherein the at least one inlet comprises multiple inlets in the floor.

5. The aligner case of claim 1, wherein the at least one outlet comprises a single outlet in the floor.

6. The aligner case of claim 1, wherein the at least one outlet comprises a single outlet in the sidewall.

7. The aligner case of claim 1, wherein the at least one outlet comprises multiple outlets in at least one of the floor and the sidewall.

8. The aligner case of claim 1, further comprising a hinge coupling the at least one door to the body.

9. The aligner case of claim 1, wherein the actuator comprises a button seated on a spring, and wherein the button is configured to release the at least one door to the open condition when pressed.

9. The aligner case of claim 1, wherein body is kidney-shaped.

10. The aligner case of claim 1, further comprising an inner wall disposed around the actuator.

11. An aligner case, comprising:
a body having a floor and a sidewall and defining an inner cavity, the body having at least one inlet in at least one of the floor and the sidewall, and the body having at least one outlet in at least one of the floor and the sidewall;
a pair of hinged doors coupleable to opposing ends of the body and transitionable between an open condition where the inner cavity is revealed, and a closed condition where the inner cavity is covered; and
an actuator configured to allow transitioning of the pair of doors between the open condition and the closed condition.

12. The aligner case of claim 11, wherein the at least one inlet comprises a single inlet in the floor adjacent the actuator.

13. The aligner case of claim 11, wherein the at least one inlet comprises multiple inlets in the floor.

14. The aligner case of claim 11, wherein the at least one outlet comprises a single outlet in the floor.

15. The aligner case of claim 11, wherein the at least one outlet comprises a single outlet in the sidewall.

16. The aligner case of claim 11, wherein the at least one outlet comprises multiple outlets in at least one of the floor and the sidewall.

17. The aligner case of claim 11, wherein the actuator comprises a button seated on a spring.

18. The aligner case of claim 17, wherein the pair of hinged doors are biased to remain in the open condition absent an external force, and wherein the button is configured to release the pair of hinged doors to the open condition when pressed.

19. The aligner case of claim 11, wherein body is kidney-shaped.

20. A method of cleaning an aligner comprising:
providing an aligner case including a body having a floor and a sidewall and an inner cavity, the body having at least one inlet in at least one of the floor and the sidewall, and the body having at least one outlet in at least one of the floor and the sidewall, at least one door coupleable to the sidewall and transitionable between an open condition where the inner cavity is revealed, and a closed condition where the inner cavity is covered, and an actuator coupled to the at least one door and configured to allow transitioning of the at least one door between the open condition and the closed condition;
introducing a liquid through the at least one inlet to clean contents of the inner cavity.
